(19) United States
(12) Patent Application Publication
(10) Pub. No.: US 2003/0021116 A1
(43) Pub. Date: Jan. 30, 2003

(54) T-bar grid tracklight system

(76) Inventors: Jack V. Miller, Seaford, DE (US); Ruth E. Miller, Seaford, DE (US)

Correspondence Address: JACK V. MILLER, 20915 Sussex Highway 13, Seaford, DE, 19973, US

(21) Appl. No.: 09/917,514

(22) Filed: Jul. 30, 2001

(51) Int. Cl. F21V 21/00

(52) U.S. Cl. 362/249

(57) ABSTRACT

A tracklight system includes an elongated an elongated metallic track generally in the shape of a U, having a base and first and second parallel depending legs with proximal ends extending from the base of the U and having distal ends terminating in a common plane. An elongated insulator is attached to at least one of the depending legs, each insulator having at least one pair of longitudinal slots therein, a first slot of each pair being wider than the second slot. A partially-imbedded elongated electrical conductor is disposed in each slot. A pair of flexible electrical wires terminate in a polarized plug and connect to a thick conductive contact blade frictionally engageable into a wide insulator slot and into contact with the conductor therein and a thin conductive contact blade frictionally engageable into a narrow insulator slot and into contact with the electrical conductor therein, whereby the first contact blade of the plug will not enter a second insulator slot, forming a polarized connection at any location along the track.

### BACKGROUND

1. Field of the Invention

This invention relates to the field of suspended ceiling systems comprised of suspended T-bar ceiling perimeter angles, main runners and cross tees forming a grid capable of supporting ceiling panels, lay-in lighting fixtures and air conditioning ducts; as well as the field of tracklights having light positionable on and connected an electrified track.

2. Description of Prior Art

A prior-art tracklight and suspended ceiling runner system is shown in the applicants' U.S. Pat. No. 5,325,272, teaching a recesed fiber optic lighting track. This prior-art track is ideal in its ability to distribute light through fiber optics to aimable fiber optic luminaires, and to hide the luminaires within a track to provide controlled illumination for musem artifacts. However, it has limited commercial application, as it does not provide the ability to mount and provide power to operate either fluorescent or incandescent light fixtures needed for general illumination.

A prior art suspended ceiling tracklight runner is shown in the Galindo U.S. Pat. No. 4,414,617 in which depending tracklight fixtures are positionable along a T-bar having a C-shaped cross-member recessed into tegular ceiling panels. This T-bar track also does not provide the ability to mount and provide power to operate fluorescent light fixtures needed for general illumination. It also requires special tegular ceiling panels with rabbetted edges.

### OBJECTS OF THE PRESENT INVENTION

The principal objects of the present invention are to provide a suspended ceiling and tracklight system that: 1) provides both general illumination as well as task lighting in a room; 2) that can position and operate a variety of track tasklighting fixtures at any location in a room; 3) that can securely support a variety of ceiling panels or fluorescent lay-in light fixtures for general illumination; and 4) that can provide air ducts and controls necessary for efficient heating, ventilation and air conditioning. It is a further object of the invention to provide a suspended ceiling and tracklight system that is easy to install in a room of any size or shape, and that is structurally sound.

### BRIEF DESCRIPTION AND ADVANTAGES OF THE PRESENT INVENTION

The objects of the present invention are achieved by a T-bar grid tracklight system including an elongated metallic main-runner track generally in the shape of an H, having a horizontal crossbar and first and second vertical sides having inner and outer surfaces with upper ends extending upwards from the crossbar of the H and lower ends extending downwards from the crossbar of the H to form outward-extending flanges in a common plane.

An elongated insulator is attached to one lower end inner surface. The insulator has pairs of longitudinal slots with a partially-imbedded electrical conductor in each slot, connected to remote electrical power mains. A bridge is slidably engageable with the upper ends of the vertical sides, and has a central area for attachment a ceiling suspension wire.

A perimeter wall angle is installed around the perimeter of a room to support the ends of the main runners with a snap bracket that locks into the end of a main runner and snaps over the top of the wall angle.

Cross tees may be main runners or may be narrower tubular cross tees that do not accommodate track lighting fixtures. Either cross tee may be attached with a snap bracket to the side of a main runner or to a wall angle.

In a preferred embodiment a wireway is snapped into position between the upper ends of the H-shaped track to distribute electrical power to any light fixture at any point in a room.

In another preferred embodiment an H-shaped track crossbar of is fenestrated to accommodate an air-conditioning supply duct above the ceiling and to flow air through a volume and direction controlling vent within the track crossbar.

### BRIEF DESCRIPTION OF THE DRAWINGS

FIG. 1 is a transverse cross-sectional view of a prior-art suspended-ceiling T-bar tracklight according to the Galindo U.S. Pat. No. 4,414,617;

FIG. 2 is a transverse cross-sectional view of a prior-art suspended-ceiling T-bar tracklight according to the applicants' U.S. Pat. No. 5,325,272;

FIG. 3 is a perspective view of a main runner of suspended-ceiling T-bar track according to the present invention.

FIG. 4 is a transverse cross-sectional view of suspended-ceiling main runner according to the present invention.

FIG. 5 is a perspective view of a main runner connector bracket engageable into the track of FIG. 3 or 4.

FIG. 6 is a longitudinal cross-sectional view of a main runner track according to the present invention showing its attachment to a perimeter wall angle with the bracket of FIG. 5;

FIG. 7 is a transverse cross-sectional view of a main runner track according to the present invention, shown attached to cross tees of main runner cross-section, with one cross tee shown electrically connected;

FIG. 8 is a perspective view of a tubular cross tee;

FIG. 9 is a perspective view of a cross tee connector bracket;

FIG. 10 is a cross-sectional view of a perimeter wall bracket of FIG. 6;

FIG. 11 is a longitudinal cross-sectional view of a tutular cross tee according to the present invention showing its attachment to a perimeter wall angle of FIG. 10 with the bracket of FIG. 9;

FIG. 12 is a cross-sectional view of the tubular cross tee of FIG. 11, taken alon section line 12-12;

FIG. 13 is a longitudinal cross-sectional view of a tubular cross tee of FIG. 8, according to the present invention, showing a pair of cross tee connector brackets of FIG. 9;

FIG. 14 is a transverse cross-sectional view of a main runner track according to the present invention, shown attached to one cross tee of main runner cross-section of FIG. 3 and a second cross tee of tubular cross section of FIG. 8;

FIG. 15 is a transverse cross-sectional view of a main runner track according to the present invention, shown supporting a ceiling panel and supporting and connecting a lay-in fluorescent light fixture;

FIG. 16 is a transverse cross-sectional view of a main runner track according to the present invention, shown supporting 2 ceiling panels and supporting and connecting a tracklight fixture;

FIG. 16 is a transverse cross-sectional view of a main runner track according to the present invention, shown supporting 2 ceiling panels, also supporting an air conditioning duct and air flow control shown in an open position;

FIG. 17 is a transverse cross-sectional view of a main runner track according to the present invention, shown supporting 2 ceiling panels, also supporting an air conditioning duct and air flow control shown in a closed position;

FIG. 18 is a transverse cross-sectional view of a main runner track according to the present invention, shown supporting 2 ceiling panels, also supporting an air conditioning duct and air flow control shown in a closed position;

FIG. 19 is a transverse cross-sectional view of a main runner track according to the present invention, shown supporting 2 ceiling panels and also supporting an air conditioning duct and air flow control shown in a right-hand flow position;

FIG. 20 is a transverse cross-sectional view of a main runner track according to the present invention, shown supporting 2 ceiling panels and also supporting an air conditioning duct and air flow control shown in a left-hand flow position;

### REFERENCE NUMERALS IN DRAWINGS

### DETAILED DESCRIPTION OF THE DRAWINGS

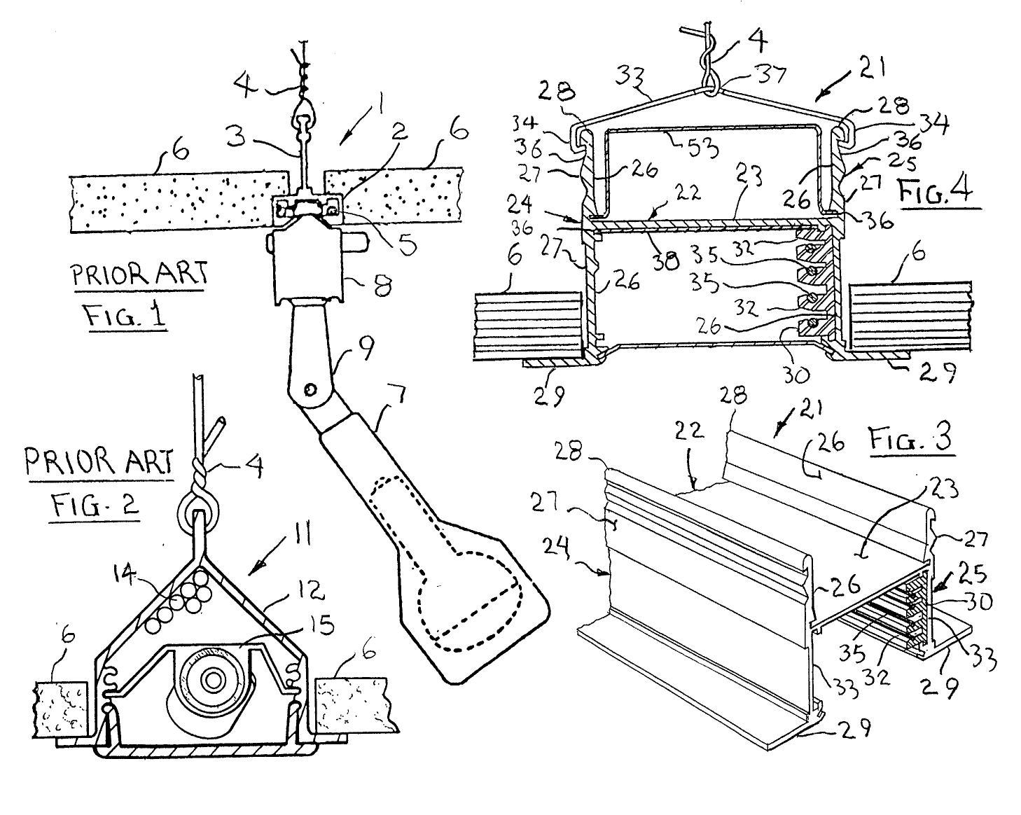

In FIG. 1 transverse cross-sectional view of a prior-art track 1 according to the Galindo U.S. Pat. No. 4,414,617 is shown having an elongated, generally “C” shaped metal track extrusion 2 having an upight rib 3 attached to a ceiling suspension wire 4. Extrusion 2 encloses a pair of insulated conductor 5 and supports tegular ceiling panels 6. A tracklight fixture 7 is shown engaged into C-shaped track extrusion 2 with a fixture adapter 8 an a trunnion 9.

In FIG. 2 transverse cross-sectional view of a prior-art track 10 according to the applicants' U.S. Pat. No. 5,325,272 is shown having an elongated, generally “U” shaped metal track extrusion 12 supporting ceiling panels 13 and enclosing a plurality of optical fibers 14 feeding light to aimable fiber optic luminaires 15.

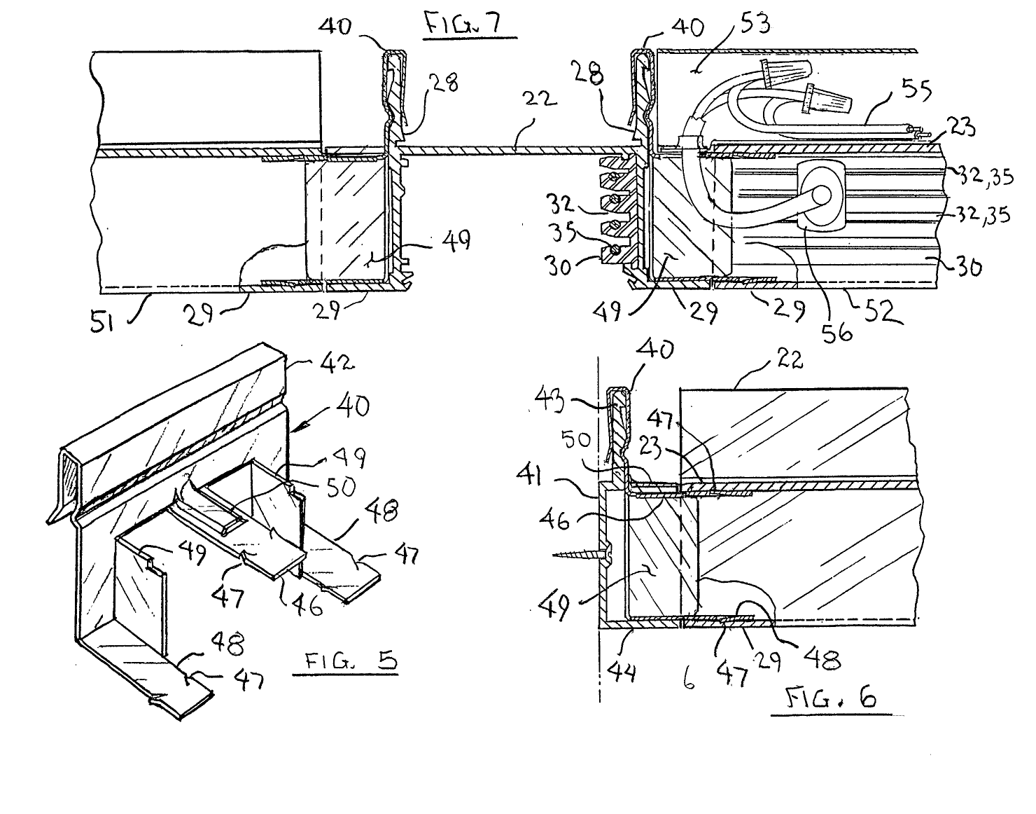

In FIG. 3 a perspective view of a main runner 21 of a T-bar grid tracklight system acccording to the present invention is shown having an elongated metallic track extrusion 22 generally in the shape of an H, having a horizontal crossbar 23 and first and second vertical sides 24, 25 having inner and outer surfaces 26, 27, with upper ends 28 extending upwards from the crossbar of the H and having lower ends extending downwards from the crossbar of the H 23 and forming outward-extending flanges 28 in a common plane. An elongated insulator 30 is shown attached vertical side 25. Insulator 30 has one or more pairs of longitudinal slots 32 therein, with a partially-imbedded elongated electrical conductor 35 in at least one side of each slot.

In FIG. 4 a transverse cross-sectional view of a main runner 21 of a T-bar grid tracklight system acccording to the present invention is shown having an elongated track extrusion 22 generally in the shape of an H, having a horizontal crossbar 23 and first and second vertical sides 24, 25 having inner and outer surfaces 26, 27, with upper ends 28 extending upwards from the crossbar of the H and having lower ends extending downwards from the crossbar 23 of the H and forming outward-extending flanges 29 in a common plane. An elongated insulator 30 is attached to an inside surface 26 of vertical side 25, said insulator 30 having one or more pairs of longitudinal slots 32 therein, with a partially-imbedded elongated electrical conductor 35 in at least one side of each slot. Bridges 33 are slidably engaged with hooks 34 into respective grooves 36 on outer surfaces 27 of vertical sides 24 and 25. each bridge having a central means 37 for attachment a ceiling suspension wire 4, attached to a ceiling, not shown. The ability of the bridges as needed to be positioned at any location along the main runners allows an installer to locate each bridge at a ceiling joist to provide secure attachments for the suspended ceiling.

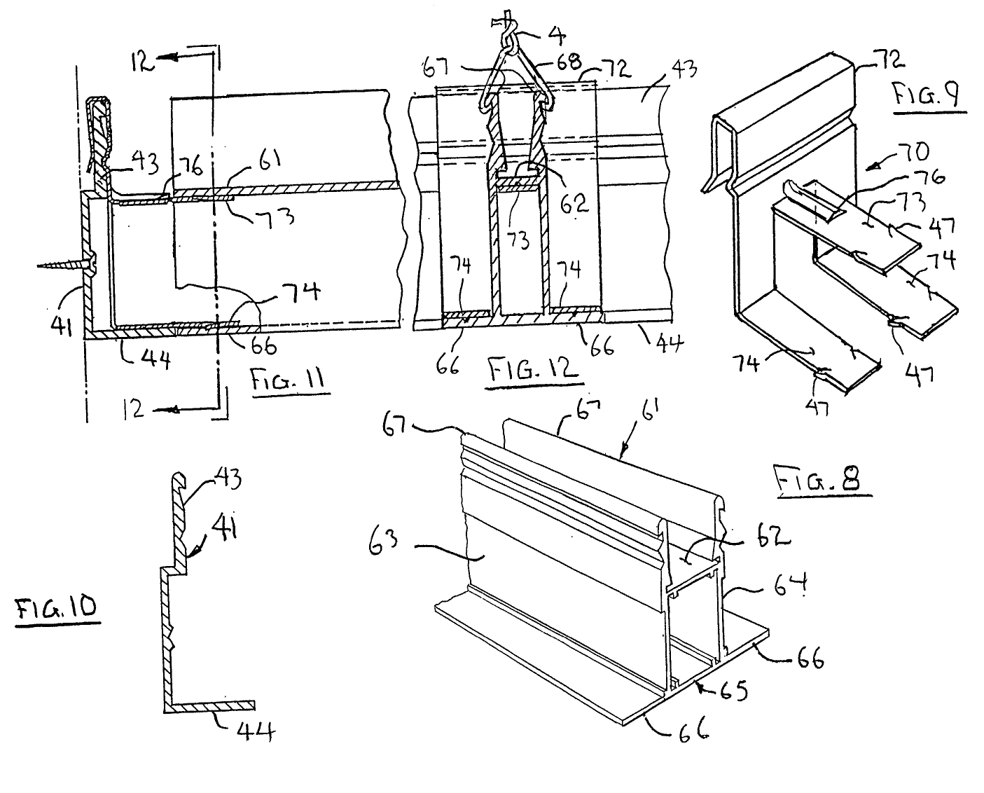

In FIG. 5 a main runner connector bracket 40 is shown engageable into an elongated track extrusion 22 to be supported on a wall angle 41 which is normally attached to the perimeter walls of a room as shown in FIG. 6. Connector bracket 40 has an inverted J-hook42 adapted to snap onto an upstanding leg 43 of perimeter wall angle 41. Wall angle 41 also has a horizontal flange 44 that aligns with flanges 29 of main runners 22.

In FIG. 6 main runner 22 is shown supported by a main runner connector bracket 40, which is snapped onto wall angle 41, with its horizontal flange 44 aligned with the horizontal flanges 29 of main runner extrusion 22. An upper arm 46 of connector bracket 40 underlies and supports the horizontal crossbar 23 of extrusion 22 and a ledge 50 on arm 47 provides an engagement stop. A pair of lower arms of connector bracket 40 overlie flanges 47 of extrusion 22. A plurality of sharp barbs 47 on the arms hold extrusion 22 against wall angle 41. A pair of side flaps 49 on connector bracket 40 provide a mechanical stop to align extrusion 22 with wall angle 41 and also provide vertical support under main runner crossbar 23.

FIG. 7 a transverse cross-sectional view of a main runner 21 of a T-bar grid tracklight system acccording to the present invention is shown with main runner extrusion 22 supporting two similar extrusions 22 connector brackets 40 forming cross tees 51 and 52. Cross tee 52 has a snap-in wireway 53, which is also shown in cross-section in FIG. 4, enclosing wires 55 from electric mains to a cord and plug 56 to power conductors 35 in the track 21. By the foregoing structure the main runners and cross tees can utilize the same extrusion 22, either with or without insulators 30 or conductors 35.

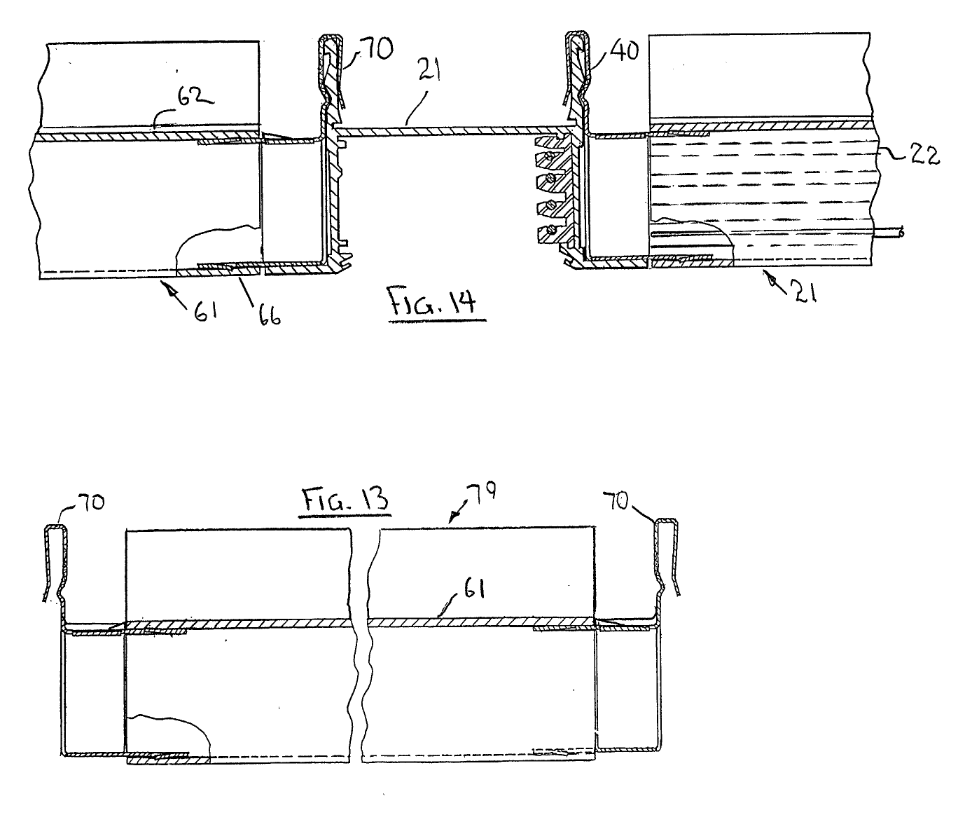

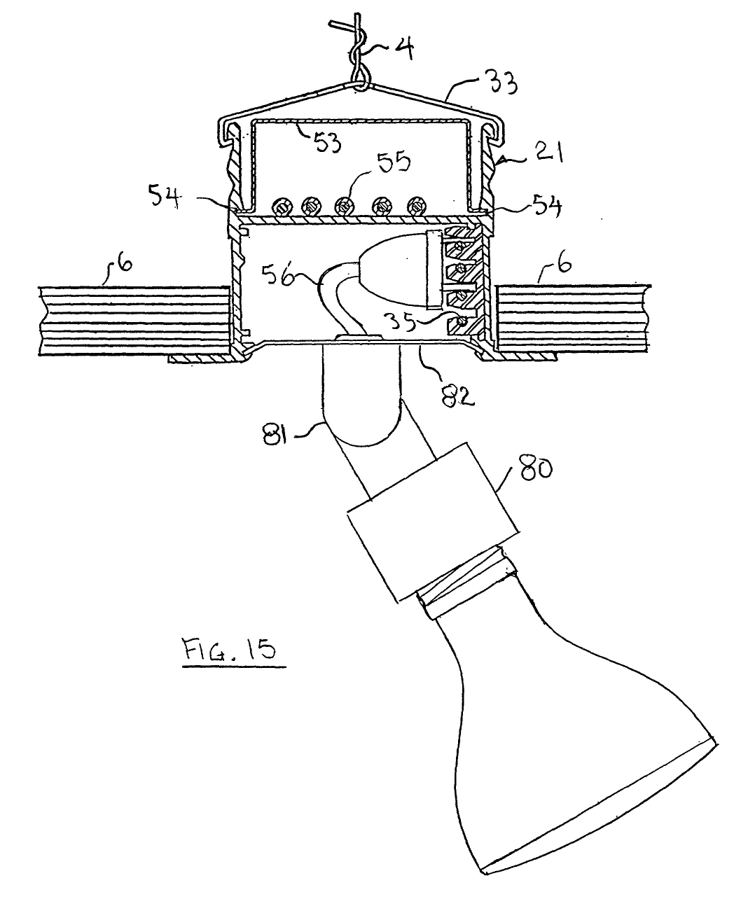

In FIG. 8 an alternative tubular cross tee 61 is shown having a top 62 and first and second sides 63 and 64 terminating in a bottom 65 including horizontal flanges 66. A cross tee connector bracket 70 of FIGS. 9, 11 and 12 is shown having a cross section nearly identical to that of main runner connector bracket of FIG. 7 and, but with a stop 76 on the upper arm of cross tee connecotr bracket to prevent cocking of cross tee 61 under load. The inverted J-shaped hook 72 of cross tee connector bracket 70 hooks over upper end 75 of perimeter wall angle 41 so that either extrusion, main runner 22 or cross tee extrusion 61 can be secured to wall angle 41. Upper arm 73 of connector bracket 70 underlies and supports the horizontal crossbar 63 of extrusion 61 and a pair of lower arms of connector bracket 70 overlie flanges 66 of extrusion 61. A plurality of sharp barbs 47 on the arms hold extrusion 61 against wall angle 41.

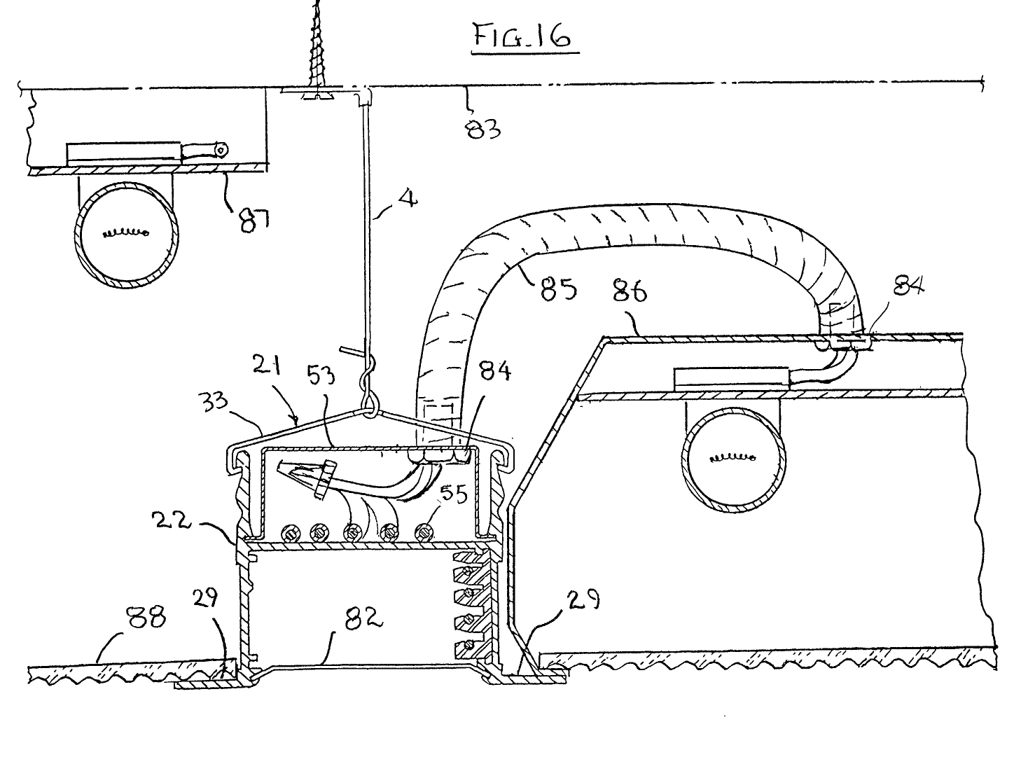

In FIG. 13 a complete tubular cross tee is shown comprised of an extrusion 61 with a cros tee connector bracket 70 at each end for engagement onto a main runner 21, shown in FIG. 14 also supporting another main runner extrusion 22 to also function as a cross tee as supported by main runner connector bracket 40.

In FIG. 15 a main runner 21 is shown supporting ceiling panels 6 and breing held by bridge 33, in turn, suspended by wire 4 to a ceiling, not shown. Main runner 21 has a wireway engaged into slots 54 in extrusion 21 and enclosing a plurality of wires 55 that are connected to conductors 35 as shown in FIG. 7. A tracklight fixture 80 is shown attached through a trunnion 81 to a fixture adapter 82 and electrically connected to conductors 35 by a cord and plug 56.

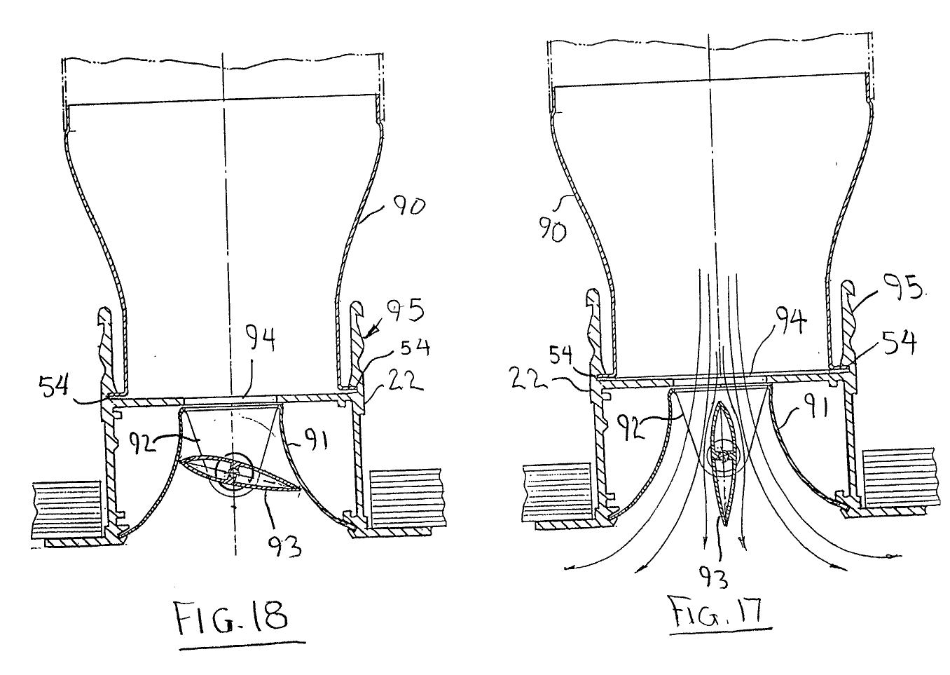

FIG. 16 shows a cross sectional view of a main runner 21 supported from a ceiling 83 by wire 4 and bridge 33. Wireway 53 includes insulated wires 55 from electrical mains, not shown. A lay-in type fluorescent light fixture 86 is shown resting on flange 29 of extrusion 22, which would be also supported on adjacent main runner or cross tee flanges. Lay-in fixture 86 is connected to insulated mains wires 55 through a flexible conduit 85 attached with conduit fittins 84 and wired by any conventional hook-up means. Another embodiment is shown wherein a surface-mount fluorescent light fixture 87 is atached to a ceiling and a lay-in lens 88 rests on flanges 29 of main runneers and/or flanges 66, not shown, of adjacent cross tees. Fixture adapter 82, instead of supporting a light fixture as shown in FIG. 15, is shown in FIG. 16 functioning as an alignment plate between two lengths of main runner 21.

In addition to supporting ceiling panels and light fixtures a T-bar grid system is often required to support air conditioning ducts as shown in FIGS. 17, 18, 19 and 20, in which an air conditioning supply duct 90 is shown engaged into slots 54 of extrusion 22, shown used as a cross tee 51. Since a cross tee is normall 24 inches long, it is an ideal size for an air conditioning outlet, which may be placed anywhere in a ceiling grid. In FIG. 17 a venturi 91 has end pivot plates 92 frictionally supporting the ends of a blade 93 shown in an open position wherby the venturi bifurcates the air flowing through a number of elongated apertures 94.

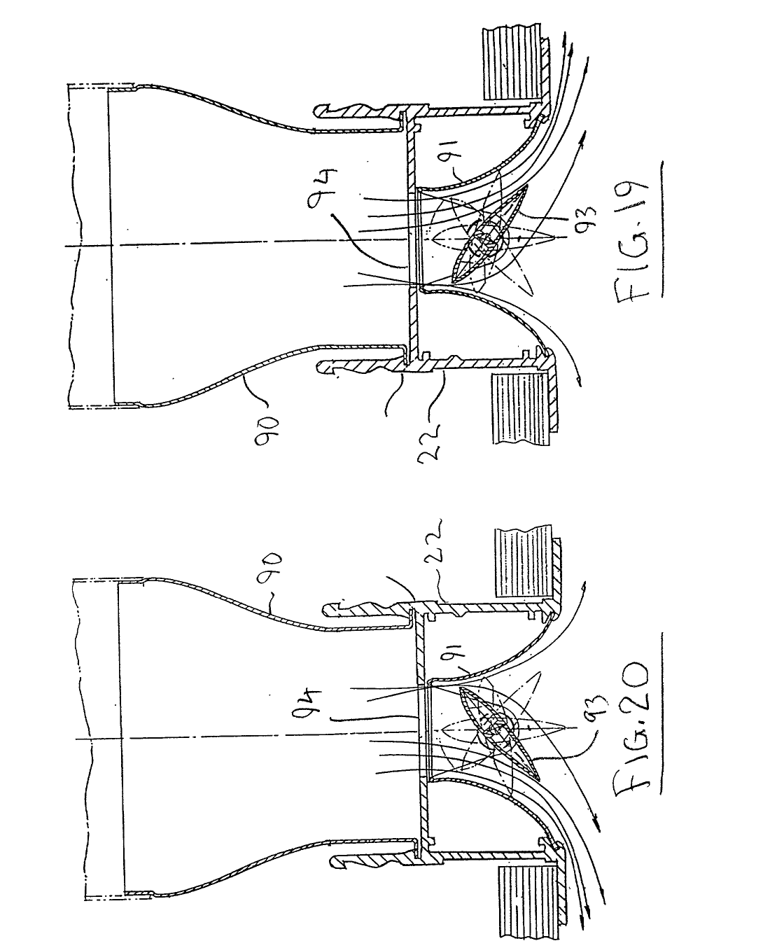

In FIG. 18 blade 93 is shown in the closed position, in FIG. 19 the blade 93 is shown flowing air primarily to the right and in FIG. 20 blade 93 is

### OPERATION, RAMIFICATIONS AND SCOPE

In operation the present invention provides great structural strength, ease of installation and versatility in configuration. Virtually any type of lighting, or none at all can be accomodated at installation or added later.

1. A T-bar grid tracklight system comprising: an elongated main runner track (21) generally in the shape of an H, having a horizontal crossbar (23) and first and second vertical sides (24,25) having inner and outer surfaces (26,27) with upper ends (28) extending upwards from the crossbar (23) of the H and having lower ends ( 33) extending downwards from the crossbar of the H and terminating in outward-extending flanges in a common plane and adapted to support ceiling panels (6) or lay-in light fixtures (86);
means (55, 56, 81,82) for supporting and electrically connecting one or more light fixtures (80) within lower ends 33 of main rummer track (21);
a bridge (33) slidably engageable with the upper ends (28) of said vertical sides, said bridge having a central means (37) for attachment a ceiling suspension wire (4);
a number of perimeter wall angles (41) attachable to walls of a room, each wall angle (41) having means (41) for attachment to a wall, an upstanding portion (43) spaced away from said wall and a horizontal flange (44) aligned with flanges (29) of main runners (22);
A number of main runner connector brackets (40) frictionally engageable into an end of a main runner track (21) and supported on a wall angle (41) with an inverted J-hook (42) that snaps over upstanding leg (43) of wall angle (41); and
A number of main runner connector brackets (40), each engageable into an end of a main runner track (51) of a length to form cross tees between parallel main runner tracks (21) and supported on upper ends (28) of main runner tracks (21) with inverted J-hooks (42) that snap over respective upstanding legs (43) of main runner track 21.

2. A T-bar grid tracklight system according to claim 1 and including a number of insulated wires (55) from remote mains, routed through an elongated wireway (53) between with upper ends (28) extending upwards from the crossbar (23) of the H, said insulated wires (55) being connected through a conduit (85) to a lay-in light fixture (86) supported on in outward-extending flanges (29) of parallel main runner tracks (21).

3. A T-bar grid tracklight system according to claim 1 in which the means means (55, 56, 82) for supporting and electrically connecting one or more light fixtures (80) within lower ends 33 of main runner track (21) includes a number of insulated wires (55) from remote mains, routed through an elongated wireway (53) between with upper ends (28) extending upwards from the crossbar (23) of the H, said insulated wires (55) being connected through a first cord and plug (56) engaged into slots (32) having conductors (35) therein, and a second cord and plug (56) also engaged into slots (32) having conductors (35) therein and thence connected to a light fixture (80) supported on a fixture adapter (82).
In FIG. 6 main runner 22 is shown supported by a main runner connector bracket 40, which is snapped onto wall angle 41, with its horizontal flange 44 aligned with the horizontal flanges 29 of main runner extrusion 22. An upper arm 46 of connector bracket 40 underlies and supports the horizontal crossbar 23 of extrusion 22 and a ledge 50 on arm 47 provides an engagement stop. A pair of lower arms of connector bracket 40 overlie flanges 47 of extrusion 22. A plurality of sharp barbs 47 on the arms hold extrusion 22 against wall angle 41. A pair of side flaps 49 on connector bracket 40 provide a mechanical stop to align extrusion 22 with wall angle 41 and also provide vertical support under main runner crossbar 23.

2. A T-bar grid tracklight system according to claim 1 in which an elongated track (21) generally in the shape of an H, having a horizontal crossbar (23) and first and second vertical sides (24,25) having inner and outer surfaces (26,27) with upper ends (28) extending upwards from the crossbar of the H and having lower ends extending downwards from the crossbar of the H and forming outward-extending flanges (29) in a common plane and adapted to support ceiling panels (6) or lay-in light fixtures (86);
an elongated insulator (30) attached to at least one lower end inner surface (26), said insulator having one or more pairs of longitudinal slots (32) therein, with a partially-imbedded elongated electrical conductor (35) in at least one side of each slot;
means (56) for connecting said electrical conductors (35) to remote electrical power mains;
a bridge (33) slidably engageable with the upper ends (28) of said vertical sides, said bridge having a central means (37) for attachment a ceiling suspension wire (4);
A T-bar grid tracklight system A T-bar grid tracklight system

3. A tracklight according to claim 1 in which the electrical device attachable to the proximal end of the flexible electrical cord is a power converter of a luminaire.

4. A tracklight according to claim 1 in which the electrical device attachable to the proximal end of the flexible electrical cord is an line-voltage end-feed connecting the track to a supply junction box at a track end.

5. A tracklight according to claim 1 in which the electrical device attachable to the proximal end of the flexible electrical cord is a second polarized plug connectable to an adjacent additional length of identical track.

6. A tracklight according to claim 1 in which the inward-facing grooves at the distal ends of the respective depending legs engage a conductive grounding connector.

7. A tracklight according to claim 6 in which the conductive grounding connector includes a male spade portion engageable into a female spade grounding connector attached to a ground wire.

8. A tracklight according to claim 1 in which the base of the U is canted at an oblique angle with respect to the parallel depending legs, and the distal ends of said legs terminate in a common perpendicular plane.

9. A tracklight including:
an elongated metallic track generally in the shape of a U, having a base and first and second parallel depending legs with proximal ends extending from the base of the U and having distal ends terminating in a common plane;
an elongated insulator attached to the first depending leg and having longitudinal slots therein facing the second depending leg;
an electrical conductor in each slot, connected to a remote source of electrical power; and
one or more luminaires connected to said conductors with a flexible wire cord terminating in a plug frictionally held in at least two slots; and

10. A tracklight according to claim 9 in which the luminaire is electrically connected through a power converter to said track conductors.
